(19) United States
(12) Patent Application Publication
(10) Pub. No.: US 2025/0066216 A1
(43) Pub. Date: Feb. 27, 2025

(54) CARBON-BASED CLATHRATE COMPOUNDS

(71) Applicant: Carnegie Institution of Washington, Washington, DC (US)

(72) Inventors: Timothy STROBEL, Washington, DC (US); Li ZHU, Washington, DC (US)

(73) Assignee: Carnegie Institution of Washington, Washington, DC (US)

(21) Appl. No.: 18/929,199

(22) Filed: Oct. 28, 2024

Related U.S. Application Data
(63) Continuation-in-part of application No. 17/951,939, filed on Sep. 23, 2022, now Pat. No. 12,129,181.
Application No. 17/951,939 is a continuation of application No. 16/810,388, filed on Mar. 5, 2020, now Pat. No. 11,691,890.
(60) Provisional application No. 62/814,024, filed on Mar. 5, 2019.

(51) Int. Cl. C01F 17/30; C01F 11/00

(52) U.S. Cl. CPC C01F 17/30; C01F 11/00; C01P 2004/38; C01P 2006/40

(57) ABSTRACT

The present invention provides carbon-based clathrate compounds, including a carbon-based clathrate compound that includes a clathrate lattice with atoms of at least one element selected from the group consisting of carbon and boron as a host cage structure and guest atoms encapsulated within the clathrate lattice. The guest atoms can constitute single elements or multiple distinct elements. In one embodiment, the invention provides a carbon-based clathrate compound of the formula NdB₃C₃. In another embodiment, the invention provides a carbon-based clathrate-like compound of the formula CaB₃C₃. In another embodiment, the invention provides a carbon-based clathrate compound of the formula NaₓSr₍₁₋ₓ₎B₃C₃.

### CROSS-REFERENCE TO RELATED APPLICATIONS

This application is a continuation-in-part of currently pending U.S. application Ser. No. 17/951,939 filed Sep. 23, 2022, which claims priority to U.S. application Ser. No. 16/810,388 filed Mar. 5, 2020, now issued as U.S. Pat. No. 11,691,890B2, which further claims priority to U.S. Provisional Application No. 62/814,024 filed Mar. 5, 2019, all filed in the United States Patent & Trademark Office, the disclosures of which are incorporated herein by reference in their entireties.

### STATEMENT OF INTEREST

This invention and/or the parent invention(s) was/were made with Government support under Grant W31P4Q-13-1-0005 awarded by DARPA and Grant DE-SC0001057 from the Department of Energy. The U.S. Government has certain rights in the invention.

### FIELD OF THE INVENTION

Aspects of the invention relate to carbon-based clathrates having the underlying formulation MB₃ₓC₃ₓ, where M is a guest atom comprising a single atom of an elemental metal and x is an integral multiplier such as compounds including NdB₃C₃ or ScB₃C₃ as well as methods of making the same. The present invention further relates to carbon-based clathrates having the underlying formulation MNB₃ₓC₃ₓ, where M is a guest atom comprising a single atom of an elemental metal, N is a second guest atom comprising a single atom of a different elemental metal, and x is an integral multiplier such as compounds including NaSrB₆C₆ and CaSrB₆C₆ as well as methods of making the same.

These structures based on the B₃C₃ framework, also known as bipartite sodalite, can have variable occupancy and/or mixtures of guest atoms. Thus, a theoretical compound could have the formulation M1_{0.5}M2_{0.5}B₃C₃ where M1 is a first guest atom and M2 is a second guest atom, allowing the general framework to have a B:C ratio of 1:1 and the total guest atom (metal) content will be 1:6. An alternate method of calculating which takes into account variable occupancy of the bipartite sodalite structures would be M1M2M3M4 . . . MnB₃C₃, where M1 is a first guest atom. M2 is a second guest atom, et cetera, and the sum of Mi to Mn=1 for a given compound.

The present invention also relates to a carbon-based clathrate-like compound with hexagonal structure having the formula CaB₃C₃.

### BACKGROUND OF THE INVENTION

As a fundamental building block of nature, carbon is unrivalled in its diversity to form stable structures with other elements and itself. One-dimensional (1D) carbon-based materials (e.g., polymers) have thoroughly reshaped society over the past century, in addition to providing the building blocks for life. In recent years, two dimensional (2D) materials, such as graphene, have attracted much attention due to remarkable properties that promise to advance technology. Three dimensional (3D) sp³ carbon-based structures, such as diamond, exhibit many superlative properties including hardness, strength, thermal conductivity and electron mobility. But aside from diamond, only a handful of materials in this class are actually known. Lonsdaleite (hexagonal diamond), B-doped diamond, SiC and BC₂N, are valuable high-tech ceramics, but they all maintain the basic structure of diamond. Boron carbide also contains sp³ hybridized carbon atoms, but these atoms serve as links between B12 icosahedra, rather than establishing the overall structural framework. From the organic perspective, 3D covalent organic frameworks (COFs), which are formed by linking sp²-hybridized molecular building blocks, have attracted much interest as materials for gas storage and separations. Compared with the exquisite synthetic control over porous COF materials, the experimental progress in denser sp³ carbon-based structures lags far behind.

Numerous 3D carbon allotropes and compounds have been predicted to have feasible energies and interesting properties. However, it was previously unclear whether any of these materials can be produced in the laboratory. Aside from the diamond structure, previously almost no other sp³ carbon-based frameworks were known or could be stabilized at atmospheric pressure. For example, longstanding predictions of 3D sp³-bonded C₃N₄ networks have not been realized previously, and high-pressure polymeric phases of CO₂, which consist of a network of CO₄ tetrahedra, decompose into molecular CO₂ phases when decompressed.

There is thus a need to predict and synthesize new 3D sp³ carbon-based structures that have useful properties. Accordingly, the principal object of the invention is to provide carbon-based structures, principally in the form of a carbon-based clathrate compound. Other objects will also be apparent from the detailed description of the invention.

### SUMMARY OF THE INVENTION

Broadly stated, the objects of the invention are realized, accordingly to one aspect of the invention, through the prediction and synthesis of carbon-based clathrate compounds that include a clathrate lattice and guest atoms. More specifically, the carbon-based clathrate compounds may include (i) a clathrate lattice with atoms of at least one element selected from the group consisting of carbon and boron as a host cage structure; and (ii) guest atoms encapsulated within the clathrate lattice.

According to one aspect of the invention, the guest atoms are neodymium (Nd). In another aspect of the invention, the guest atoms may also include Sc, Ca, Sr, La, Ba, Y, Ce, Pr, Pm, Sm, Eu, Er, Tm, Tb, Lu, or other atoms with a similar ionic radii including other lanthanides.

According to one aspect of the invention, the structure of the carbon-based clathrate compound is cubic bipartite sodalite.

According to one aspect of the invention, the clathrate lattice includes cages, each cage including 24 atoms with six four-sided faces and eight six-sided faces.

According to another aspect, the invention is a compound of the formula MB₃C₃ where M is a single atom of a guest metal.

According to another aspect of the invention, the MB₃C₃ compound is a carbon-based clathrate. In another embodiment, the structure of the carbon-based clathrate is cubic bipartite sodalite. In another embodiment of the invention, the compound comprises a clathrate lattice with atoms selected from the group consisting of carbon and boron as a host cage structure. In another embodiment of the invention, the clathrate lattice is formed of sp³ hybridized carbon and boron.

According to one aspect of the invention, M is a guest atom encapsulated within the clathrate lattice. According to another aspect of the invention, the clathrate lattice comprises cages, each cage comprising 24 atoms with six four-sided faces and eight six-sided faces.

Advantageously, the compound of the formula MB₃C₃ may have semiconducting properties, metallic properties, or superconducting properties according to the selection of guest metal atom M. Also, the compound may have ferroelectric or ferromagnetic properties.

According to one aspect of the invention, the invention is a compound of the formula MNB₆C₆ (hereafter a “binary guest” configuration) where M is a single atom of a guest metal and N is a single atom of another guest metal. According to another aspect of the invention, the invention is a compound of the formula MₓN_{y}B₃C₃ where M is a plurality of atoms of a guest metal and N is a plurality of atoms of another guest metal, and where x is the molar fraction of guest metal atoms M and y is the molar fraction of guest metal atoms N.

According to another aspect of the invention, the MNB₆C₆ compound is a carbon-based clathrate. (As set forth above, an alternate formulation for this is MₓN_{y}B₃C₃ where x+y=1 for any given substructure.) In another embodiment, the structure of the carbon-based clathrate is cubic bipartite sodalite. In another embodiment of the invention, the compound comprises a clathrate lattice with atoms selected from the group consisting of carbon and boron as a host cage structure. In another embodiment of the invention, the clathrate lattice is formed of sp³ hybridized carbon and boron.

According to one aspect of the invention, the M and the N are guest atoms encapsulated within the clathrate lattice. According to another aspect of the invention, the clathrate lattice comprises cages, each cage comprising 24 atoms with six four-sided faces and eight six-sided faces. In another embodiment, the M atoms are captured within that part of the cage comprising six four-sided faces and the N atoms are captured within that part of the cage comprising eight six-sided faces.

Advantageously, the compound of the formula MNB₆C₆ may have semiconducting properties, metallic properties, or superconducting properties according to the selection of guest metal atoms M and N. (As above, this can also be stated as MₓN_{y}B₃C₃ where x+y=1 or MₓN₍₁₋ₓ₎B₃C₃ for any given substructure) Also, the compound may have ferroelectric or ferromagnetic properties.

A further advantage of a binary guest configuration is that it allows for the careful tuning of the electronic structure and enables high-temperature superconductivity in some systems with predictions approaching 100K. Higher order guest configurations can also allow such control.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention is more fully described by reference to the following detailed description and the accompanying drawings wherein:

FIG. 1A is a ternary phase diagram of a Sr—B—C system at 50 GPa. Circles (green) represent thermodynamically stable compounds while squares (orange) represent additional metastable compositions used in the search.

FIG. 1B is a ternary convex hull for the Sr—B—C system at 50 GPa based on formation enthalpies. Compounds with enthalpy data represented by points (red) are on the convex hull and thermodynamically stable against decomposition. Black points (the points not on the hull) show the formation enthalpies of metastable structures found in the structure searches.

FIG. 2 provides the structure of an SrB₃C₃ clathrate. The structure also may represent the LaB₃C₃ Clathrate, with La as the guest atom. The cubic structure is composed of face-sharing boron-carbon cages that encapsulate Sr or La atoms. Each cage contains 24 atoms with six four-sided faces and eight six-sided faces (4668). Different color cages are used to emphasize the stacking of cages that tile 3D space.

FIG. 3A provides experimental x-ray diffraction data collected at 57 (3) GPa with Rietveld refinement of the SrB₃C₃ phase. More specifically, the experimental X-ray diffraction data (black points) was collected at 57 (3) GPa with Rietveld refinement (blue line) of the SrB₃C₃ phase. Green ticks indicate contributions from Ne with Le Bail refinement. The 2D diffraction cake image aligned with the integrated pattern shows nearly complete powder averaging with sharp peaks for the SrB₃C₃ phase. The inset shows a magnified view at high angle with sharp SrB₃C₃ peaks to a limiting resolution of 0.75 Å.

FIG. 3B provides experimental EoS and calculated EoS data for the SrB₃C₃ phase. Experimental EoS (solid blue line) with B0=249 (3) GPa, B0′=4.0 (fixed) and calculated EoS (dashed lines) with B0 (DFT-LDA)=257 GPa, B0′=4.0 (fixed); B0 (DFT-GGA)=225 GPa, B0′=4.0 (fixed). Different colored symbols represent data points from six independent experimental runs.

FIG. 4A provides electronic properties of SrB₃C₃ and in particular a two-dimensional electron localized function (ELF) for the compound.

FIG. 4B provides electronic band structures for SrB₃C₃ at 0 GPa projected onto atomic orbitals, where the width of each band is proportional to the weight of the corresponding orbital character. The projected density of states and Crystal Orbital Hamilton Population (COHP) between adjacent B and C atoms in SrB₃C₃ at 0 GPa are shown to the right. The Fermi energy is set to 0 eV (dashed line).

FIG. 5 provides an image showing in situ synthesis of SrB₃C₃ with laser heating in a diamond anvil cell.

FIG. 6A shows phonon dispersion, phonon density of states and electron-phonon integral of SrB₃C₃ at 0 GPa.

FIG. 6B shows Tc as a function of pressure for SrB₃C₃.

FIG. 7 (A-D) show calculated stress-strain relations of SrB₃C₃. FIG. 7A and FIG. 7B show calculated tensile stress-strain relations for SrB₃C₃ with GGA (FIG. 7A) and LDA (FIG. 7B). FIG. 7C and FIG. 7D show calculated shear stress-strain relations for SrB₃C₃ in the (110) easy cleavage plane with GGA (FIG. 7C) and LDA (FIG. 7D).

FIG. 8 provides an XRD pattern showing LaB₃C₃ recovered to low pressure. The Powder XRD pattern of LaB₃C₃ is shown during decompression at 5 GPa (top), and after opening the cell in air (bottom). Bragg positions from cubic LaB₃C₃ are marked by blue lines. The diffraction intensity was limited by the opening angle above 20=14°. When exposed to air, LaB₃C₃ degrades into unknown, presumably, hydrolysis products. Diffraction from unreacted LaB₃C₃ can still be observed in air several minutes after the cell was opened.

FIG. 9A shows computed stability of LaB₃C₃ via different reaction pathways indicating exothermic formation from pure elements and from stable binaries above ca. 20 GPa.

FIG. 9B shows Rietveld refinement of LaB₃C₃ at 57 (2) GPa with a=4.66307 (8) Å, wRp-Bknd=0.042, χ²=3.8. The sample is nearly phase pure with a trace impurity of unreacted LaB₆. Inset shows well-resolved peaks to a limiting resolution of 0.80 Å. The 2D cake image, presented above the integrated pattern, indicates uniform powder averaging. The pattern obtained before heating (grey trace) shows only cubic LaB₆ and Ne; ballmilled LaC₂ and glassy carbon appear amorphous.

FIG. 9C provides unit cell volume of LaB₃C₃ as a function of pressure. Experimental data were fitted using a third-order Birch-Murnaghan EoS with B₀=254 (9) GPa and B₀′=3.6 (4). DFT results yield B₀=248 GPa with B₀′=3.8 (PBEGW) and B₀=268 GPa with B₀′=3.9 (LDA).

FIG. 10 shows phonon dispersion for LaB₃C₃ at 1 atm showing dynamic stability.

FIG. 11 provides stress-strain calculations for LaB₃C₃ with GGA and LDA., indicating a high ideal strength with hardness near 30 GPa.

FIG. 12 provides raw XRD patterns of SrB₃C₃ before and after heating.

FIG. 13 provides raw XRD patterns of SrB₃C₃ with increasing pressure and heating.

FIG. 14 provides Sr—B—C phase identification at 155 (6) GPa with Ne medium.

FIG. 15 provides Sr—B—C phase identification at 142 (10) GPa with Al₂O₃ medium.

FIG. 16 presents data showing the stability of SrB₃C₃ and analysis of possible stoichiometries.

FIG. 17 shows X-ray diffraction of SrB₃C₃ at atmospheric pressure.

FIG. 18 provides electronic band structure for SrB₃C₃ at 200 GPa projected onto atomic orbitals.

FIG. 19A and FIG. 19B provide energetic stabilities as a function of pressure, with FIG. 19A showing calculated enthalpies per SrC₂ unit as a function of pressure for various structures with respect to 14/mmm structure, and FIG. 19B showing calculated enthalpies per SrB₆ unit as a function of pressure for various structures with respect to Pm3̅m structure.

FIG. 20 provides the structure of LaB₃C₃ viewed along different crystallographic directions. C and B atoms make up the framework, while La is trapped in the cages. The single 4668 cage has one unique B-C distance of 1.74 Å at atmospheric pressure.

FIG. 21A shows the difference in charge density for LaB₃C₃ (crystal density minus isolated atomic density) viewed in the (100) plane at 0 GPa.

FIG. 21B shows the electronic band structure (HSE) of LaB₃C₃ at 0 GPa with density of states. Contributions from different orbitals are indicated.

FIG. 22 provides an EDX map of recovered sample showing showing homogeneous elemental distribution in heated region (25×25 μm²) with average composition La_{1.00±0.07}B_{2.95±0.06}C_{4.20±0.09}O_{0.46±0.07}. The carbon content is biased by adventitious sources, also observed on pure standards. The color composite map is layered over the SEM image and individual elements from the same region are shown below.

FIG. 23 shows the computed phonon dispersion relations for various MB₃C₃ compounds exhibiting dynamic stability at 1 atm.

FIG. 24 shows formation enthalpies of MB₃C₃ compounds versus pressure, showing calculated enthalpies per MB₃C₃ unit as a function of pressure for various clathrates in the Pm3̅n structure type.

FIG. 25A shows single-crystal refinement parameters for NdB₃C₃ at 50 GPa.

FIG. 25B shows the electronic band structures for NdB₃C₃ at 50 GPa projected onto atomic orbitals, where the width of each band is proportional to the weight of the corresponding orbital character. The Fermi energy is set to 0 eV (dashed line).

FIG. 25C shows the crystal structure of NdB₃C₃ where black, purple and orange spheres represent carbon, boron and neodymium atoms, respectively. The cubic structure is composed of face-sharing boron-carbon cages that encapsulate Nd atoms. Each cage contains 24 atoms with six four-sided faces and eight six-sided faces (4668).

FIG. 26A shows Powder X-ray diffraction patterns for binary Type-VII clathrates produced by CaB₆+SrC₂+4 C→_CaSrB₆C₆. Peaks with asterisks are from unreacted precursor.

FIG. 26B shows Powder X-ray diffraction patterns for binary Type-VII clathrates produced by 2SrB₆+Na₂C₂+10 C→_2NaSrB₆C₆ (right). Peaks with asterisks are from unreacted precursor.

FIG. 27A shows a sample geometry for in situ electrical transport with HPHT synthesis of MB₃C₃ compounds.

FIG. 27B shows an image of in situ synthesis of SrB₃C₃ with laser heating in a diamond anvil cell.

FIG. 27C shows experimental data showing x-ray diffraction data for SrB₃C₃ before and after heating.

FIG. 28A shows experimental data showing the resistance drop during cooling of a first sample of SrB₃C₃ to a base temperature of 5 K at 54 GPa. The heating trace (green overlay) follows the same path with no detectable hysteresis. The inset shows the determination of the Tc onset by extrapolation of linear regions.

FIG. 28B shows experimental data showing the normalized resistance for several cooling runs at different pressures for the first sample of SrB₃C₃ and a second sample of SrB₃C₃. The inset shows the pressure dependence of experimental T_{c} onset values SrB₃C₃ (points) compared with calculations using different values of μ* (lines).

FIG. 28C shows experimental data showing the resistance of a third sample of SrB₃C₃ at 40 GPa as a function of temperature and magnetic field.

FIG. 28D shows experimental data showing the upper critical field, μ₀H_{c2}(T), for the transition onset of SrB₃C₃ (black points) compared with the WHH model (α=0, blue curve). A linear fit (red dashed line) is shown to guide the eye.

FIG. 29A shows the two-dimensional structure of the compound RbSrB₆C₆.

FIG. 29B shows the computed phonon dispersion, phonon density of states and electron-phonon integral of the compound RbSrB₆C₆ with dynamic stability at 1 atm.

FIG. 30A shows the resistance curve versus temperature of the compound NaₓSr_{y}B₃C₃

FIG. 30B shows the T_{c} versus P curve of the compound SrB₃C₃ versus the T_{c} versus P curve of a Na-doped Type-VII clathrate.

FIG. 31A shows the two-dimensional structure of the clathrate-like compound h-CaB₃C₃.

FIG. 31B shows the three-dimensional structure of the clathrate-like compound h-CaB₃C₃ along the c-axis.

FIG. 31C shows electronic band structure and density of states data for the compound h-CaB₃C₃. The Fermi energy is set to 0 eV (dashed line).

### DETAILED DESCRIPTION OF THE INVENTION

Note: For purposes of this application, U.S. application Ser. No. 16/810,388 filed Mar. 5, 2020 and U.S. application Ser. No. 17/951,939 filed Sep. 23, 2022, both of which further claim priority to U.S. Provisional Application No. 62/814,024 filed Mar. 5, 2019 and all three of which are incorporated herein by reference, will be referred to collectively as “the Prior Applications.”

Carbon clathrate is an impressive 3D sp³ material. Carbon-based clathrates are open-framework structures composed of host cages that trap guest atoms in which all host atoms are linked by four-coordinate bonds. As sp³-bonded frameworks, carbon-based clathrates represent strong and lightweight materials that also offer tunable properties through manipulation of the occupancy and type of guest atoms within the cages. Despite their prominence in other systems with tetrahedral coordination, carbon-based clathrates have not previously been reported due to tremendous challenges associated with their synthesis.

Attempts to synthesize carbon clathrates go back at least 50 years since they were postulated following the formation of inorganic silicon clathrates, and their possible structures and properties are of longstanding interest. However, carbon clathrates have not been successively synthesized previously. Some proposed but unrealized carbon clathrates are expected to exhibit exceptional mechanical properties with tensile and shear strengths exceeding diamond, while large electron-phonon coupling is predicted to give rise to conventional superconductivity with high transition temperatures. If produced, these materials may represent a class of diamond-like compounds wherein the electronic structure is tunable by adjusting the occupancy of electron-donating (or withdrawing) atoms within the cages.

The inventors have performed a substantial amount of research to answer the persisting question of whether carbon clathrate structures are accessible by experiment. First-principles DFT calculations indicate that both filled and guest-free carbon clathrates are energetically unfavorable but by energies as low as 0.07 eV/atom relative to diamond (for reference, commercially produced C₆₀ is metastable by nearly six times that energy). Synthesis of carbon clathrates might therefore proceed through a non-equilibrium pathway (e.g., formation from a high-energy precursor or deposition method) or through a chemical substitution/doping strategy to modify the intrinsic thermodynamic stability. No successful metastable pathways to carbon clathrates have been established previously, although three-dimensional polymers of C₆₀ have been suggested to resemble carbon clathrate-like structures.

While non-equilibrium synthesis pathways remain feasible in concept, another strategy is to substitute boron for carbon atoms within the cage frameworks of carbon clathrates. The electron deficient nature of boron creates the ability to form complex chemical bonding with itself or carbon to stabilize polyhedra, such as the icosahedral units in molecular carborane clusters. Zeng et al. calculated that boron substitution can improve the intrinsic thermodynamic stability of carbon clathrate frameworks. Nevertheless, no thermodynamically stable carbon-clathrate was previously predicted after examination of a small subset of possible B substitution schemes in Li-filled carbon clathrates. A broad search of potential B substitution schemes was therefore needed to validate this chemical stabilization principle. Here, the inventors established the first thermodynamically stable carbon-based clathrate using automatic structure searching methods and validated the prediction via high-pressure and high-temperature experiments, thus expanding known sp³ carbon materials to a new class with tunable properties.

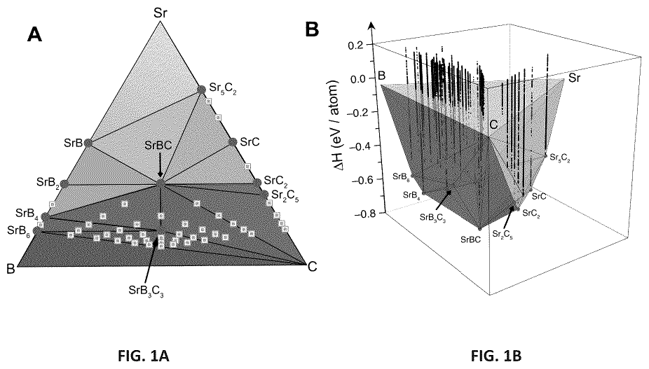

The inventors conducted an extensive computational search in the Sr—B—C system (including pure elements, binaries and ternaries from SrBₓC_{y} with 0≤x, y≤6) at pressures from 0-200 GPa after broader searching in ternary B-C systems with a variety of metals including Li, Na, Mg and Ca. For the Sr—B—C system, several high-pressure compounds were determined to be thermodynamically stable with respect to elemental mixtures (see FIG. 1A and FIG. 1B). At 50 GPa, the hexagonal P6₃/mmc and γ-B structures were calculated to be the most stable forms of Sr and B, respectively, while diamond is the most stable structure for C. The compounds Sr₅C₂, SrC, SrC₂, Sr₅C₂, SrB, SrB₂, SrB₄, and SrB₆ were found to be the stable binaries on the convex hull at 50 GPa (discussed below in more detail). The inventors found no energetically stable B-C binary compounds above 50 GPa, in agreement with a previous computational study.

Two stable ternary compounds were predicted at 50 GPa. The first, hexagonal SrBC (space group P6₃/mmc), exhibits two-dimensional layers of six-membered B-C rings stacked between layers of Sr atoms, similar to intercalated graphite. This new SrBC phase is isostructural with LiBC found at ambient pressure. The second ternary compound is cubic (space group Pm3̅n)) with composition 2Sr@B₆C₆ (SrB₃C₃) and has the type-VII clathrate structure, known for the clathrate hydrate HPF₆·6H₂O and related to inorganic compounds such as BaPd₂P₄ through a small structural distortion. The topology of SrB₃C₃ is that of bipartite sodalite (sod-b), which is distinguished from the sodalite structure (sod) in that carbon atoms are only bonded to boron atoms and vice versa. This is the first prediction of a thermodynamically stable carbon-based clathrate.

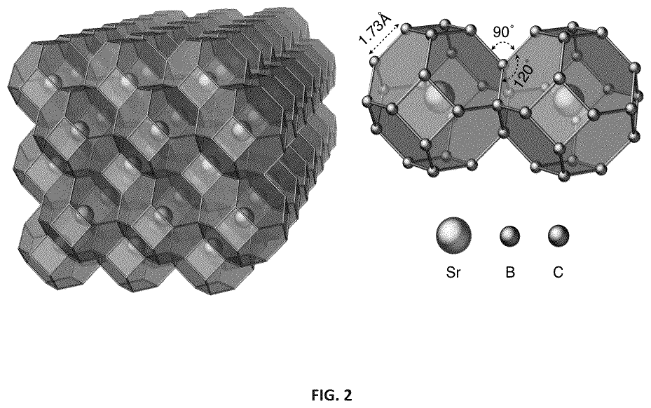

The SrB₃C₃ clathrate framework (FIG. 2) is composed of a single truncated octahedral cage with six four-sided faces and eight six-sided faces (4668). The cages are comprised of 24 vertices with alternating C and B atoms and each cage contains a single Sr atom at the center. This type-VII clathrate phase is predicted to be thermodynamically stable from 50 to at least 200 GPa. The material does not exhibit imaginary phonon frequencies at any pressure indicating dynamic stability and favorable conditions for metastable recovery to ambient conditions. At zero pressure, the optimized lattice parameter is 4.88 Å, and the structure contains one unique B-C bond length of 1.73 Å. The boron-doped clathrate is much more stable than its pure carbon counterpart: at 50 GPa, 2Sr@C₁₂ is metastable by 0.667 eV/atom, while 2Sr@B6C₆ lies on the convex hull.

DFT calculations show that at 50 GPa SrB₃C₃ is a stable product of exothermic reactions of the pure elements and of readily accessible binary compounds. Therefore, the inventors conducted diamond-anvil cell (DAC) experiments using homogeneous fine-grained mixtures of SrB₆, SrC₂ and glassy C targeting the stoichiometric reaction SrB₆+SrC₂+4C→2SrB₃C₃. Additional experiments were conducted using only mixtures of binary compounds where the most energetically favorable reaction was calculated as SrB₆+3SrC₂→SrB₃C₃+3SrBC. Mixtures of the powders were compressed in Ne or Al₂O₃ media and heated near ˜2500 K using an infrared fiber laser while synchrotron X-ray diffraction patterns were collected to monitor structural changes in situ.

The starting SrB₆ possesses the LaB₆ (Pm3̅m) structure, whereas SrC₂ takes on the acetylide structure of CaC₂ (l4/mmm). When compressed at room temperature, SrB₆ remains in the starting cubic phase and SrC₂ transforms to the R3̅m structure (BaC₂ type) above 14 GPa, eventually appearing amorphous to X-rays above 50 GPa. Upon heating near 2500 K, the intensities of diffraction peaks from the starting compounds vanish and a series of new reflections appear. At 57 (3) GPa, these sharp lines were initially indexed to a phase-pure BCC cubic lattice with a=4.5972 (2) Å, in excellent correspondence with the type-VII SrB₃C₃ clathrate (Pm3̅n) with a calculated lattice parameter of a=4.593 Å at the same pressure.

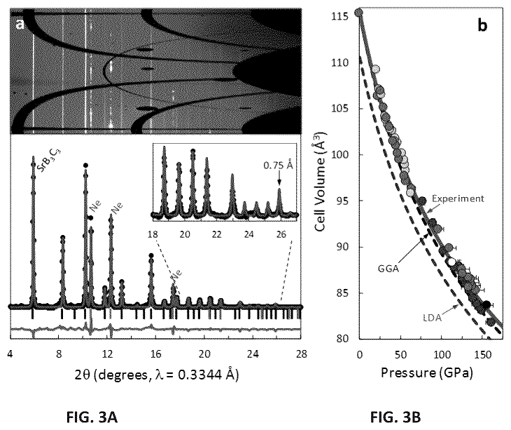

The calculated X-ray diffraction pattern of the SrB₃C₃ clathrate is compared with experimental scattering data in FIG. 3A and FIG. 3B. Given the nearly complete experimental powder averaging statistics, the quantitative diffraction intensities are representative of atomic positions and are in excellent agreement with the calculated pattern of SrB₃C₃ clathrate to the experimental resolution limit of 0.75 Å. All allowed reflections with calculated intensity are observed to this limit, consistent with the formation of SrB₃C₃ clathrate.

Given the large contrast in electron density between Sr and the framework atoms, the heavier element dominates the intensity of scattered X-rays. While the formation of SrB₃C₃ is strongly supported by the stoichiometric conversion of the starting materials, the intensities of the allowed reflections that differentiate the primitive bipartite structure from the BCC sodalite version are in fact negligible, and the possibility for another type of cubic Sr lattice must be considered. The inventors exclude a new elemental Sr lattice that could potentially describe these data based on the requirement of large Sr—Sr distances near 3.8 Å, which are >1.1 Å larger than the distances between Sr atoms in the known metallic phases at this pressure. Other Sr compounds with cubic sublattices are excluded by the experimental P-V EOS, which uniquely distinguishes clathrate cage structures based on agreement with DFT calculations over a broad pressure range from 0-150 GPa. SrB₃C₃ and other higher-energy cage variants are much less compressible than all other stable and metastable elemental structures and binary/ternary compounds calculated except pure boron allotropes and diamond.

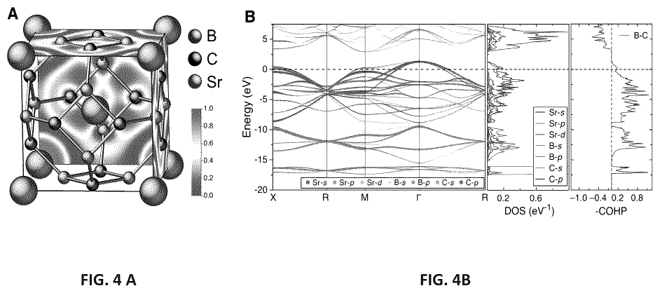

The SrB₃C₃ framework exhibits strong covalent bonding between sp³-hybridized B and C atoms, and weak interactions with the Sr guest. This strong sp³-hybridized covalent framework guarantees a high value for the bulk modulus (B0=249 (3) GPa) and incompressibility of SrB₃C₃ clathrate. Based on electron count, SrB₃C₃ should be a hole conductor, and calculations show it is. The reasoning is as follows: All all-carbon, four-coordinate zeolites are insulators at low pressures, closed-shell systems analogous to diamond. A sodalite all-carbon clathrate would be that, and so would isoelectronic [C₃B₃]³⁻. SrB₃C₃ is one electron per formula unit short of this magic (insulator) electron count. Indeed, the band structure (FIG. 4B) shows this—a good gap for one electron more than SrB₃C₃. See also FIG. 4A.

SrB₃C₃ clathrate is likely the first member of a new class of strong and lightweight sp³-bonded carbon-based frameworks with tunable properties. Because boron anions are isoelectronic to carbon atoms in the B-C framework, the bipartite structure should exhibit similar properties to hypothetical pure carbon cages. Furthermore, the ability to trap various kinds of guest atoms in the sp³-bonded cages allows the carbon-based clathrates to possess diamond-like mechanical properties with a tunable electronic structure. While SrB₃C₃ is metallic, the electronic structure may be modified by substituting different guest atoms. For example, LaB₃C₃, which the inventors also predict to be thermodynamically stable at high pressure, possesses a band gap due to the balanced electron count. The removal of guest atoms from the cages offers an additional space to explore with the possibility for guest-free structures. Although SrB₃C₃ is only thermodynamically stable at high pressure, the inventors find that it is recoverable to atmospheric pressure, similar to diamond, which is produced on an industrial scale. At 1 atm, SrB₃C₃ persists when kept under an inert atmosphere, but it begins to degrade when exposed to the moisture in air over prolonged time (hours). The extent to which alternative clathrate structure types are achievable through different boron substitution/guest schemes are being investigated, and the formation pressure and stability may be optimized. The results may also shed light on the role of element substitution in stabilizing entirely different framework structures. It is likely that the framework stabilization principle observed here with boron is applicable to other elements, including more electronegative ones like nitrogen. There are prospects to obtain a much richer landscape for new carbon-based materials with advanced properties by applying this stabilization principle.

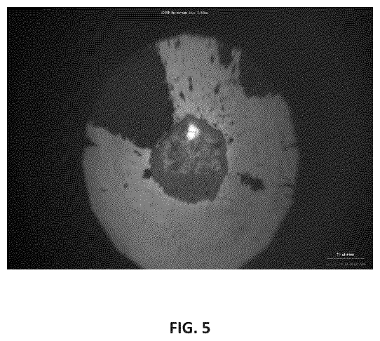

FIG. 5 provides an image showing in situ synthesis of SrB₃C₃ with laser heating in a diamond anvil cell. The central hole contains the sample with a laser hot spot that is rastered over the samples. The reflective box is sample converted to SrB₃C₃; the bottom portion is unconverted.

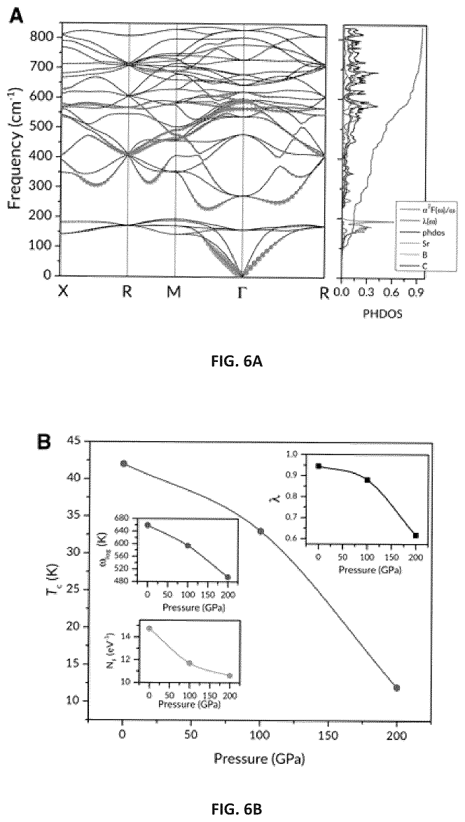

FIG. 6(A) and 6(B) demonstrate the superconducting transition temperature of SrB₃C₃. FIG. 6(A) shows phonon dispersion, and phonon density of states (PHDOS) and electron-phonon integral λ(ω) of SrB₃C₃ at 0 GPa. FIG. 6(B) shows T_{c} as a function of pressure. The insets show the evolution of λ and ω_{log} with pressure. The superconducting transition temperature, T_{c}, was estimated from the Allen-Dynes modified McMillan equation, and a typical value of the Coulomb pseudopotential μ*=0.1 was used. The calculated T_{c} is 42 K at ambient pressure.

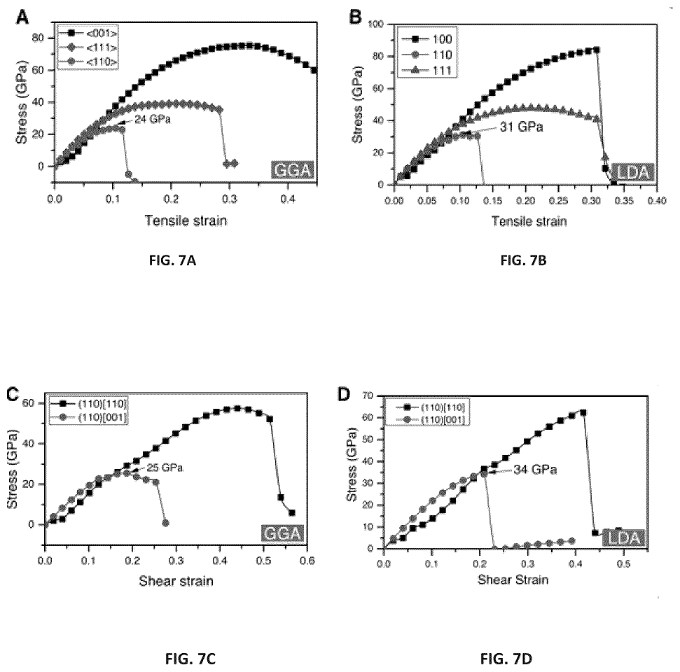

FIG. 7(A-D) show calculated stress-strain relations of SrB₃C₃. More specifically, FIGS. 7A and 7B show calculated tensile stress-strain relations for SrB₃C₃ with GGA (7A) and LDA (7B). FIGS. 7C and 7D show calculated shear stress-strain relations for SrB₃C₃ in the (110) easy cleavage plane with GGA (C) and LDA (D). The stress response along different deformation paths under tensile and shear strains, combined with the lowest peak stress defines the corresponding ideal strength, which is the maximum stress that a perfect crystal can sustain before yielding to a plastic deformation. The established method was applied to determine the stress-strain relations for SrB₃C₃ under tensile strains in three principal crystallographic directions. The lowest value of calculated peak stress is 24 GPa (31 GPa with LDA) along the <110> direction, which indicate that the <110> direction is the weakest tensile direction, and thus the (110) planes are the easy cleavage planes. The inventors next evaluate the shear stress response in the (110) “easy cleavage plane” of SrB₃C₃. The lowest peak shear stress of 25 GPa (34 GPa with LDA) in the (110) [110] shear direction. These strength values place SrB₃C₃ as a very hard material with a hardness between 24-34 GPa.

According to one aspect of the invention, the inventors have predicted and synthesized the carbon-based clathrate structure with La as the guest atom. The clathrate compound LaB₃C₃ is different in many respects from other carbon clathrate compounds discussed above.

The inventors report a carbon-based clathrate with composition 2La@B6C₆ (LaB₃C₃). Like SrB₃C₃, the La version crystallizes in the cubic bipartite sodalite structure (type VII clathrate) with La atoms encapsulated within truncated octahedral cages comprised of alternating carbon and boron atoms. The covalent nature of B-C bonding results in a rigid, incompressible framework, and due to the balanced electron count, La³⁺[B3C₃]³⁻ is a semiconductor with an indirect band gap estimated near 1.29 eV. Given that different guest atoms can be substituted within the clathrate cages, it is possible that a broad range of boron-stabilized carbon clathrates with varying properties may be synthesized with ranging physical properties.

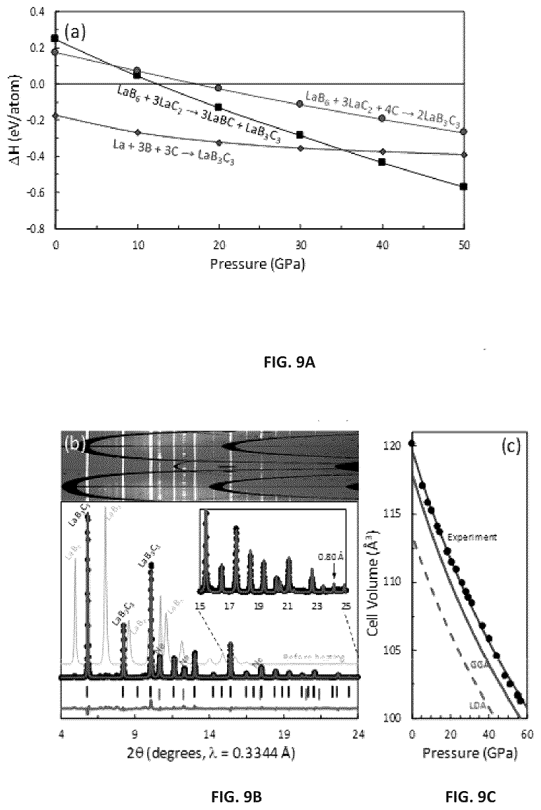

To probe the possibility of forming the bipartite sodalite-type carbon-boron clathrate with a trivalent guest, the inventors first performed first-principles structure searching computations using the CALYPSO method. Like the case of SrB₃C₃, the inventors predicted that LaB₃C₃ becomes stable under high-pressure conditions. After conducting a computational survey of binary and ternary compounds in the La—B—C system, the inventors estimate that LaB₃C₃ is the exothermic product of stable binary compounds and/or single components above about 20 GPa (FIG. 9A). Compared with calculations for SrB₃C₃, the pressure required for LaB₃C₃ is reduced by about 20 GPa—a much more favorable synthetic condition that we tentatively attribute to the overall balanced electron count.

According to one aspect of the invention, LaB₃C₃ was synthesized according to the reaction LaB₆+LaC₂+4C→2LaB₃C₃ at high pressure using diamond anvil cells. After heating near 2500 K with an infrared fiber laser, the starting precursor was converted into an essentially phase-pure cubic phase (FIG. 9A), as expected for the clathrate (space group Pm3̅n). At 57 (2) GPa, the experimental lattice parameter a=4.66 Å is in good agreement with a DFT optimized LaB₃C₃ structure with a=4.63 Å at 60 GPa (PBEGW), and Rietveld refinement of the powder data show excellent agreement with the predicted clathrate structure (FIG. 9B). In addition, the stoichiometric conversion from the homogeneous precursor to a single phase strongly supports the 1La:3B:3C composition, and a uniform single-phase region near this composition was also confirmed using energy-dispersive X-ray spectroscopy (EDX) mapping on the recovered product. Experimentally, the inventors confirmed the formation of LaB₃C₃ at 38 GPa but did not observe conversion at 35 GPa, placing a tentative bound on the minimum required synthesis pressure. Compared with SrB₃C₃ synthesized near 50 GPa, this represents a significant pressure reduction and suggests promise for future stabilization efforts at even milder conditions.

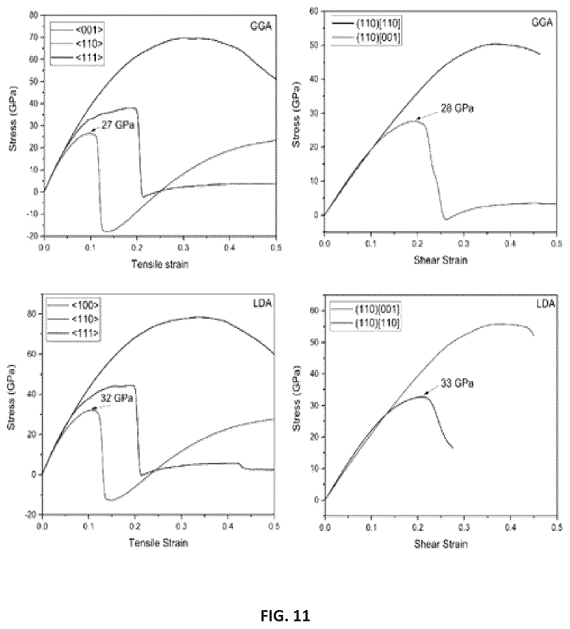

Synchrotron X-ray diffraction patterns collected during decompression confirm the clathrate framework of LaB₃C₃ based on compressibility. The decompression data were fitted using a third-order Birch-Murnaghan equation of state (EoS) with the zero-pressure bulk modulus B0=254 (9) GPa and it's derivative B0′=3.6 (4). The bulk modulus compares favorably with calculations based on DFT (FIG. 11C), noting that LDA significantly underestimates the volume for a given pressure. LaB₃C₃ is very incompressible with B0 in the range of technical ceramics used for armor, such as B4C (B0=243 (3) GPa), and the observed bulk modulus cannot be explained by any structures other than the clathrate. Similar to SrB₃C₃, the La counterpart is recoverable to ambient conditions, but must be preserved carefully under an inert atmosphere. When samples are exposed to air/moisture, they degrade into what is presumed to be hydrolysis products. Several attempts to prepare samples for transmission electron microscopy by focused ion beam milling were unsuccessful and resulted in oxidized amorphous material.

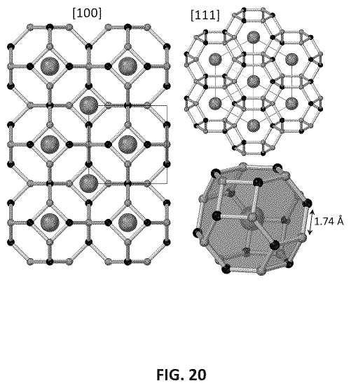

Like SrB₃C₃, LaB₃C₃ is predicted to crystallize in the cubic bipartite sodalite structure (FIG. 20). This structure type is known for the clathrate hydrate HPF₆·6H₂O and is related to inorganic compounds such as BaPd₂P₄ through a small structural distortion, as well as superhydrides such as Ca/YH₆ and CaYH₁₂. The clathrate structure is comprised of a single truncated octahedral B₁₂C₁₂ cage with six four-sided faces and eight six-sided faces (4668). All faces are shared between cages so that the single cage type can fully tile three-dimensional space without any voids. All atoms are on special crystallographic positions so that there is only one unique C-B distance and one unique C(B)-Sr distance. The square and hexagonal faces result in a mixture of 90° and 120° C.-B-C bond angles. The incorporation of B within the framework reduces the energetic penalty for the 90° bond angles.

Given the strong contrast in electron density between framework and guest atoms, powder diffraction can neither distinguish the positions and occupancies of boron and carbon (i.e., the “coloring” of the clathrate lattice) nor the weak intensity reflections that differentiate the primitive (bipartitie) and body-centered cubic (sodalite) lattices. The inventors therefore conducted single-crystal diffraction on suitable grains produced by laser heating at high temperatures above 3000 K. Similar to the case of SrB₃C₃, the observation of {120} reflections with significant intensity confirms the primitive space group Pm3̅n, and the ordered bipartite structural model produces the lowest reliability factor between experimental observations compared with other possible coloring schemes.

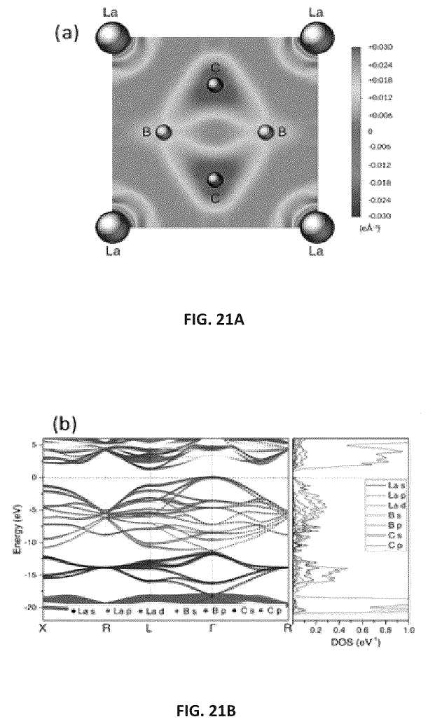

At 0 GPa, the LaB₃C₃ lattice is slightly expanded compared with that of SrB₃C₃ (a=4.934 Å vs. 4.868 Å). This is somewhat surprising as the ionic radius of La³⁺ is expected to be smaller than that of Sr²⁺ (1.36 Å vs. 1.44 Å for 12-fold coordination), see http://abulafia.mt.ic.ac.uk/shannon/radius.php. The increased cell size and thus B-C bond length in LaB₃C₃ (1.74 Å vs 1.72 Å SrB₃C₃) can be understood as additional charge transferred from guest to host. Indeed, charge density analysis (FIG. 21A and FIG. 21B) show that 1.82 e⁻ are transferred from La to the B/C host lattice, whereas 1.35 e⁻ are transferred for the case of Sr.

The electronic band structure of LaB₃C₃ also reveals the influence of the additional electron. Unlike SrB₃C₃, which is one electron short of a band gap, LaB₃C₃ shows an indirect gap of 1.29 eV in the Γ→L direction. The top of the valence band is composed primarily of hybrid p states of B and C, while the conduction band is constituted primarily of d states from La. LaB₃C₃ is comparable to B-substituted silicon frameworks such as K₇B₇Si₃₉ and LiBSi₂ with electron precise frameworks in which the metals act as electron donors, as in Zintl phases.

Summarizing the above, a second carbon-boron clathrate in the bipartite sodalite structure was prepared with La guest atoms. Unlike metallic SrB₃C₃, LaB₃C₃ has a balanced electron count and is predicted to be a semiconductor. This balanced count is also likely responsible for the improved synthetic conditions, i.e., >20% reduction in synthetic pressure. The observation of two clathrate structures indicates that many other type-VII clathrates may be possible with different guest atoms. The inventors suggest that entirely different clathrate structure types also may be possible with different carbon:boron ratios and cage types. Carbon-based clathrates thus represent a class of new materials with highly tunable properties.

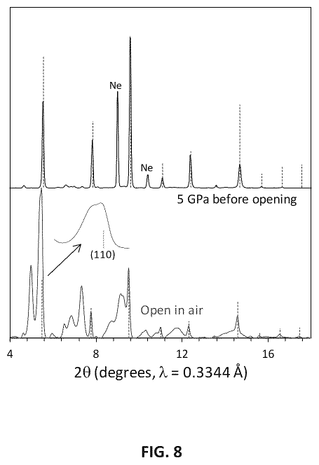

FIG. 8 provides a powder XRD pattern of LaB₃C₃ during decompression at 5 GPa (top), and after opening the cell in air (bottom). Bragg positions from cubic LaB₃C₃ are marked by blue lines. The diffraction intensity was limited by the opening angle above 2θ=14°. When exposed to air, LaB₃C₃ degrades into unknown, presumably, hydrolysis products. Diffraction from unreacted LaB₃C₃ can still be observed in air several minutes after the cell was opened.

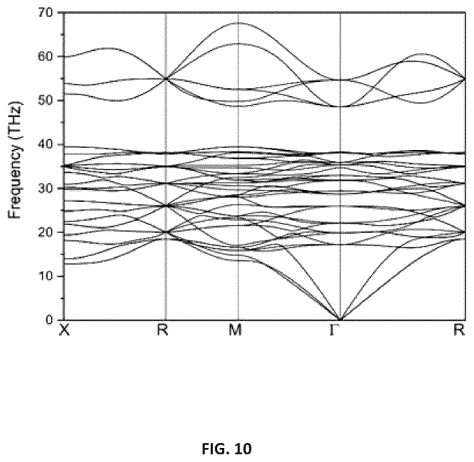

FIG. 10 provides phonon dispersion for LaB₃C₃ at 1 atmosphere, showing dynamic stability.

FIG. 11 provides stress-strain calculations for LaB₃C₃ with GGA and LDA. The calculations indicate a high ideal strength with hardness in near 30 GPa.

According to one aspect of the invention, the starting precursors to form the carbon clathrate compounds are borides, carbides and pure carbon.

Both the La and the Sr-based carbon clathrates are recoverable to ambient conditions but must be preserved under an inert atmosphere (e.g., argon) due to degradation in air.

SrB₃C₃ is predicted to be a hole metal with a high superconducting transition temperature near 42 K. LaB₃C₃ is predicted to be a semiconductor. The clathrate structures exhibit a high bulk modulus near 25 GPa and are predicted to exhibit high strength and hardness.

According to one aspect embodiment of the invention, the carbon-based clathrate structures are composed of entirely sp³ hybridized carbon and boron, which results in diamond-like bonding. In an embodiment of the invention, different guest atoms may be substituted within the cages to create a new class of diamond-like materials with tunable properties. Many other guest atoms are calculated to be possible within the clathrate cages.

Different boron substitution schemes may result in entirely different clathrate structures. Other elemental substitution schemes for the host lattice may be possible, for example N instead of B.

### Examples

The following is a more detailed description of the present invention with reference to working examples for prediction, synthesis of compounds and characterization of the same. The present invention is in no way limited to the following examples.

### Calculations

Structure-searching calculations were performed using the CALYPSO structure prediction method based on the global minimization of free energy using ab initio total-energy calculations. This method was benchmarked using various systems, ranging from elements to binary and ternary compounds. Total energy calculations were performed in the framework of density functional theory within the Perdew-Burke-Ernzerhof generalized gradient approximation as implemented in the VASP (Vienna Ab Initio Simulation Package) code. The projector-augmented wave (PAW) method (50) was adopted with the PAW potentials taken from the VASP library where 4s²4p⁶5s², 2s²2p¹ and 2s²2p² are treated as valence electrons for Sr, B and C atoms, respectively. The use of a plane-wave kinetic energy cutoff of 520 eV and dense k-point sampling, adopted here, were shown to give excellent convergence of total energies. Electronic charges were calculated using a Bader charge analysis scheme using a 600×600×600 Fast Fourier Transform grid. Phonon dispersion calculations were performed to determine the dynamical stability of the predicted structures by using the finite displacement approach, as implemented in the Phonopy code. Electron-phonon coupling calculations for superconducting properties of stable phases were performed using density-functional perturbation theory (DFPT) with the Quantum-ESPRESSO package. To study interatomic interactions, crystal orbital Hamilton population (COHP) analysis was performed using the LOBSTER package.

### Synthesis

Strontium metal was purified by sublimation (950° C., dynamic vacuum) onto Mo foil from a graphite crucible; graphite powder was pre-treated at 950° C. under dynamic vacuum for 16 h to remove adsorbed species. Strontium carbide (SrC₂) was prepared by heating 2.780 g Sr (31.7 mmol) with 0.371 g graphite powder (30.9 mmol) in a capped graphite crucible under dynamic vacuum at 825° C. for 16 h. Excess Sr was subsequently sublimed at 950° C. and the resulting, pale grey SrC₂ powder (1.400 g, 81% yield) isolated from the crucible under Ar. Powder XRD showed a small SrO impurity. SrB₆ (EPSI Metals, 99.5%) and glassy carbon (Sigma Aldrich, 99.95%) were purchased commercially and used without further purification. Binary (SrB₆+3SrC₂) and ternary (SrB₆+SrC₂+4C) mixtures were prepared under an inert Ar atmosphere, sealed, then milled vigorously using Si₃N₄ media at 600 rpm for one-minute cycles over ˜12 hours. The milled powders were removed from the media in an Ar glovebox and thin plates (10 μm) were pressed between two diamond anvils with 1 mm culets, then loaded into DAC sample chambers utilizing 100-300 μm culets and Re gaskets. Ne or alumina plates served as the pressure transmitting media and thermal insulation from the diamond anvils. After being compressed to the target pressure between 50-150 GPa, samples were heated to ˜2500 K using the double-sided laser heating systems at HPCAT or GSECARS.

### X-Ray Diffraction

In situ X-ray diffraction patterns were collected at the Advanced Photon Source, Sector 16, HPCAT using a monochromatic wavelength of 0.4066 Å and at Sector 13, GSECARS using a monochromatic wavelength of 0.3344 Å. The X-ray beam was focused on the sample and scattered X-rays were detected using a PILATUS 1M or MARCCD detector. The sample-to-detector distance and geometrical parameters were calibrated using CeO₂ and LaB₆ standards with the DIOPTAS software. Pressure was calibrated using the equations of state of Ne and and/or Al₂O₃ and cross-checked using the SrO equation of state and ruby fluorescence in some samples. Rietveld refinements of XRD patterns were conducted using Powdercell and GSAS with EXPGUI.

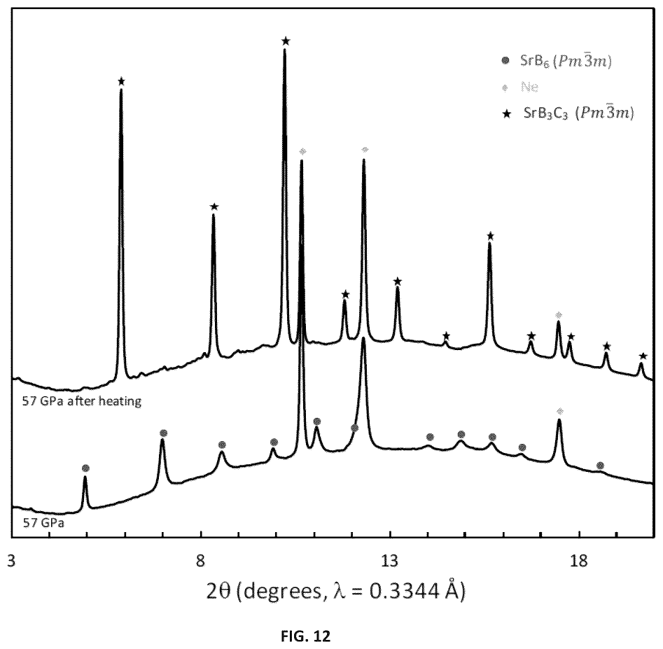

FIG. 12 provides raw XRD patterns before and after heating. The starting material is a mixture of SrB₆ (Pm3̅m), SrC₂ (l4/mmm) and glassy C in a 1:1:4 molar ratio, e.g., 2Sr:6C:6B. SrC₂ and glassy carbon appear to be amorphous to X-rays and are not distinguishable from crystalline SrB₆. After heating to a maximum temperature of ˜2900 K, the stoichiometric 1Sr:3C:3B mixture was converted to nearly phase pure SrB₃C₃ with trace residual SrB₆.

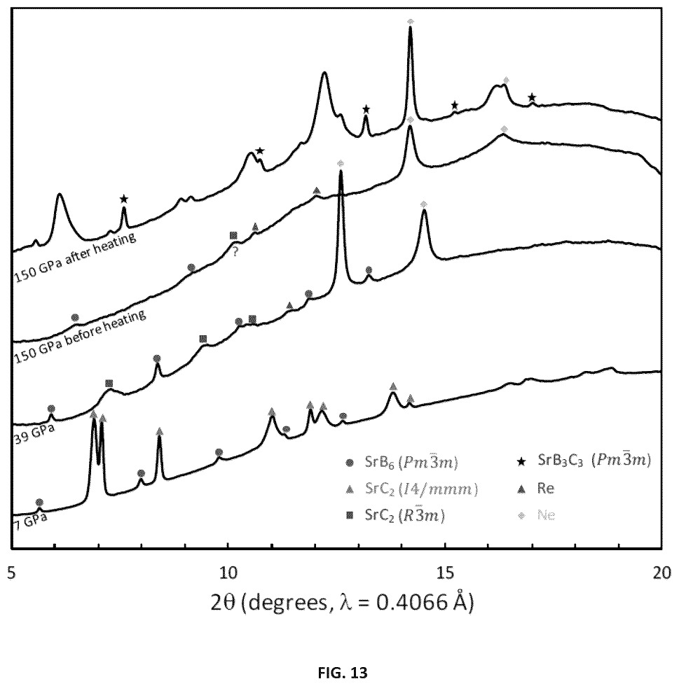

FIG. 13 provides raw XRD patterns with increasing pressure and heating. The starting material is a mixture of SrB₆ (Pm3̅m) and SrC₂ (l4/mmm) in a 1:3 molar ratio. Above 14 GPa, SrC₂ transforms to the R3̅m structure. All Bragg peaks broaden significantly and diminish in intensity with pressure due to significant stress accumulation prior to heating. Above ca. 50 GPa, SrC₂ appears to become amorphous to X-rays; one broad feature is potentially attributable to the R3̅m phase. After heating at ˜150 GPa, many new Bragg peaks appear, which can be attributed to SrB₃C₃, SrBC and a high-pressure form of SrB₆, as described below.

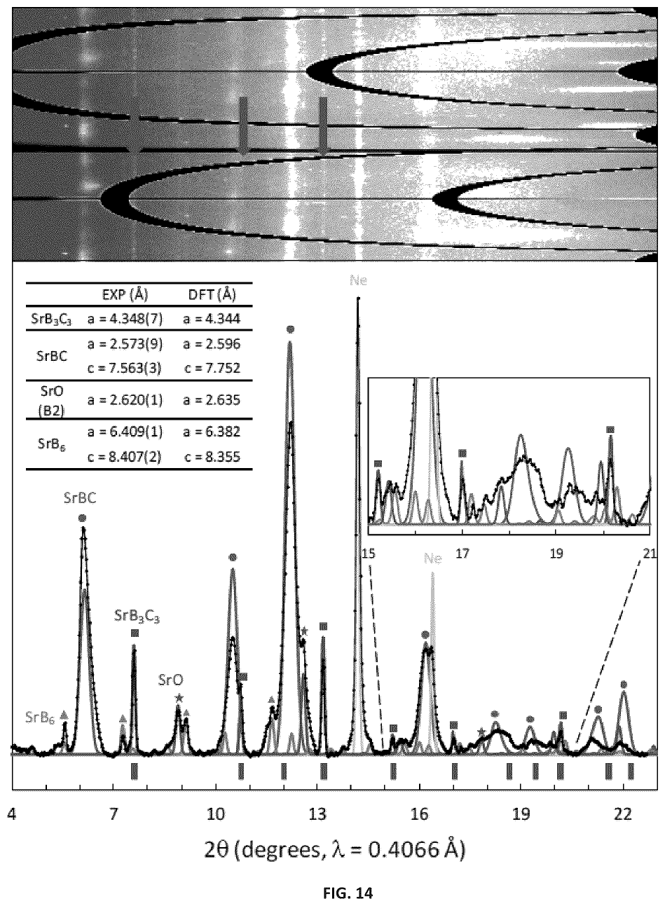

FIG. 14 demonstrates Sr—B—C phase identification at 155 (6) GPa with Ne medium. The starting material is a mixture of SrB₆ (Pm3̅m) and SrC₂ (l4/mmm) in a 1:3 molar ratio. The data indicate the reaction SrB₆+3SrC₂→SrB₃C₃+3SrBC (and some unconverted SrB₆ in a high-pressure phase), which is calculated to be the most energetically favorable reaction for these conditions. Experimental data are shown as black points connected by a thin black line. Each phase is labeled with a different symbol; tick marks below the pattern indicate allowed reflections for SrB₃C₃ (Pm3̅m). Rietveld refinement was conducted using only a Gaussian peak width and scale parameter. All atomic positions were taken from DFT-optimized structures shown in Tables S1 and S2 below. Powder averaging statistics vary between phases. Experimentally refined lattice parameters are compared with DFT (PBE) optimizations at 155 GPa. The inset to the right shows quantitative intensity agreement for SrB₃C₃ to the limiting resolution of d=1.16 Å. The 2D cake image is presented at the top of the figure with arrows indicating prominent sharp lines for SrB₃C₃.

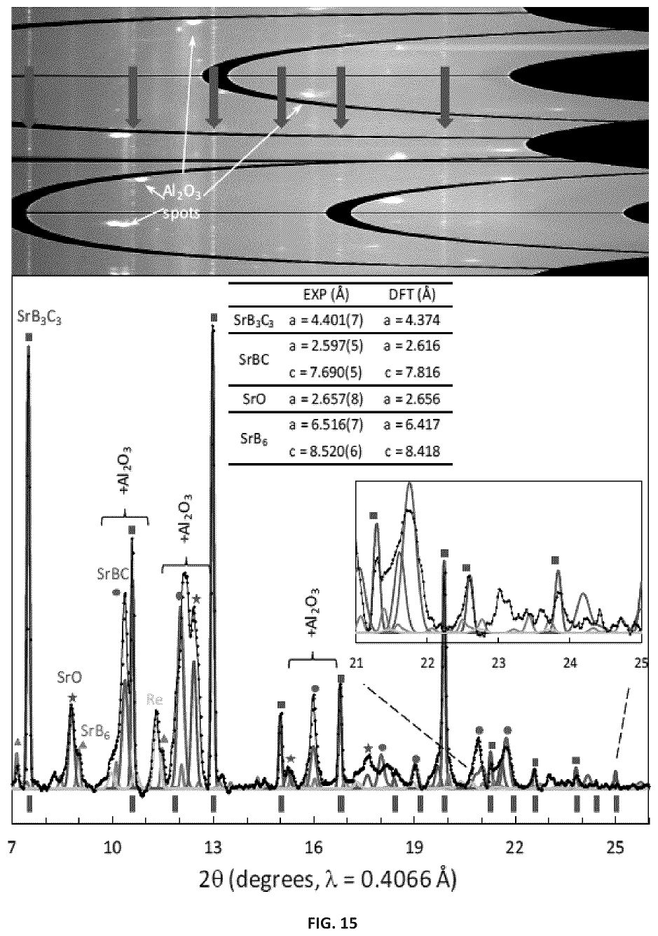

FIG. 15 shows Sr—B—C phase identification at 142 (10) GPa with Al₂O₃ medium. The starting material is a mixture of SrB₆ (Pm3̅m) and SrC₂ (l4/mmm) in a 1:3 molar ratio. The data indicate the reaction SrB₆+3SrC₂→SrB₃C₃+3SrBC (and some unconverted SrB₆ in a high-pressure phase), which is calculated to be the most energetically favorable reaction for these conditions. Experimental data are shown as black points connected by a thin black line. Each phase is labeled with a different symbol; tick marks below the pattern indicate allowed reflections for SrB₃C₃ (Pm3̅m). Rietveld refinement was conducted using only a Gaussian peak width and scale parameter. All atomic positions were taken from DFT-optimized structures shown in Tables S1 and S2 below. Powder averaging statistics vary between phases. Experimentally refined lattice parameters are compared with DFT (PBE) optimizations at 140 GPa. The inset to the right shows quantitative intensity agreement for SrB₃C₃ to the limiting resolution of d=0.93 Å. The 2D cake image is presented at the top of the figure with arrows indicating prominent sharp lines for SrB₃C₃. Single-crystalline Al₂O₃ peaks were masked, but some powder intensity was unavoidable due to the breaking of crystals during compression to 140 GPa.

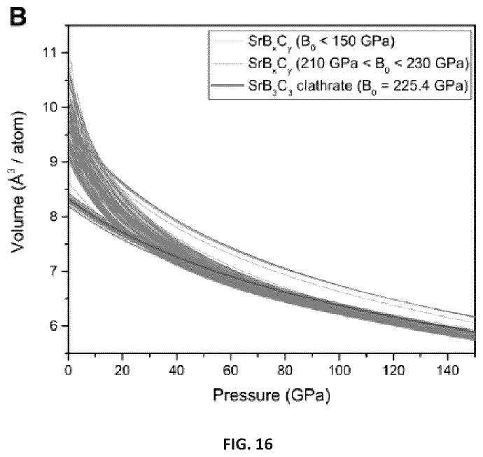

FIG. 16 shows stability of SrB₃C₃ and analysis of different possible stoichiometries. Relatedly, FIG. 1B shows predicted formation enthalpies of various Sr—B—C compounds with respect to elemental decomposition at 50 GPa. Compounds with enthalpy data represented by red points are on the convex hull and thermodynamically stable against decomposition. Black points show the formation enthalpies of metastable structures found in the CALYPSO structure searches. Blue points above the convex hull indicate the formation enthalpies of 600 additional structures containing up to 112 atoms with compositions SrBₓC_{y} (excluding SrB₃C₃). These 600 structures were determined from searches wherein the Sr atoms were constrained to a tolerance within the experimentally determined cubic positions, while the C and B atoms were allowed to freely fluctuate. No composition was found to be more stable than SrB₃C₃. FIG. 16 shows the calculated EoS of the 600 SrBₓC_{y} compounds presented in FIG. 1B. The red line shows the EoS of SrB₃C₃ clathrate, which agrees with experiment. The grey lines represent the EoS of different SrBₓC_{y} compounds with calculated B0<150 GPa, while the cyan lines indicate the structures with calculated B0 in the range of 210 to 230 GPa. After a careful analysis, we found that all the structures from the cyan group can be classified as type-VII clathrate structures (e.g., 4668 cages with different B:C compositions) whereas structures from the grey group are not cage-like structures and are more compressible. As the experimental EoS is located in the cyan group, and SrB₃C₃ is the lowest energy structure determined, the synthesized product is only consistent with a clathrate structure that should be identical or similar to the structure of cubic SrB₃C₃.

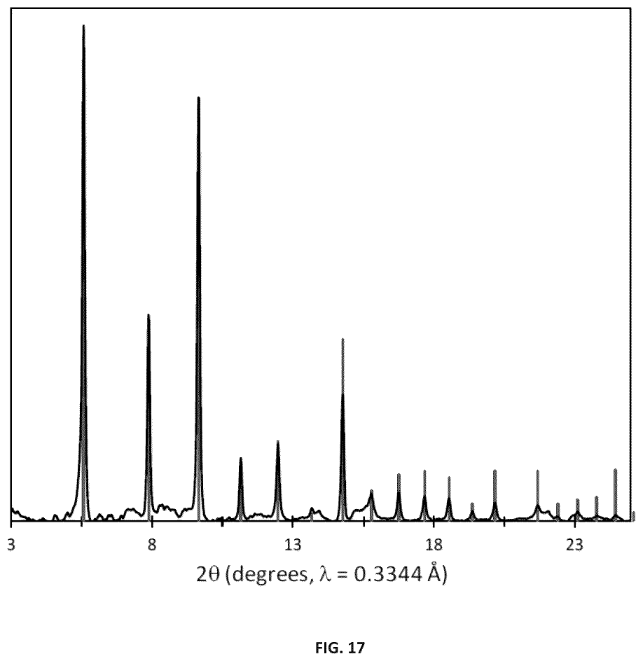

FIG. 17 shows X-ray diffraction of SrB₃C₃ at atmospheric pressure. After synthesis at ˜57 GPa, the cell was decompressed, the neon gas was released and XRD patterns were collected after the cell was sealed at 1 atm. The refined lattice parameter of a=4.868 Å compares well with DFT-GGA calculations where a=4.88 Å. Red bars indicate calculated positions for the cubic clathrate structure. When left in open air, SrB₃C₃ appears to degrade and is thus sensitive to moisture and/or oxygen.

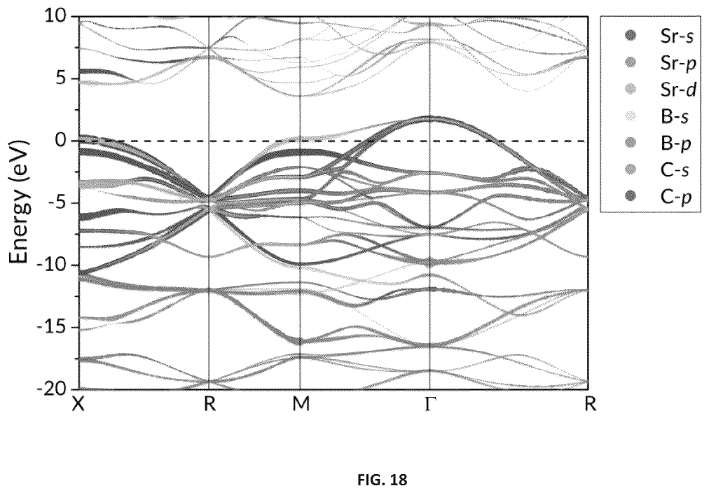

FIG. 18 provides electronic band structure for SrB₃C₃ at 200 GPa projected onto atomic orbitals represented by different colors. The width of each band is proportional to the weight of the corresponding orbital character. The dashed line indicates the Fermi energy.

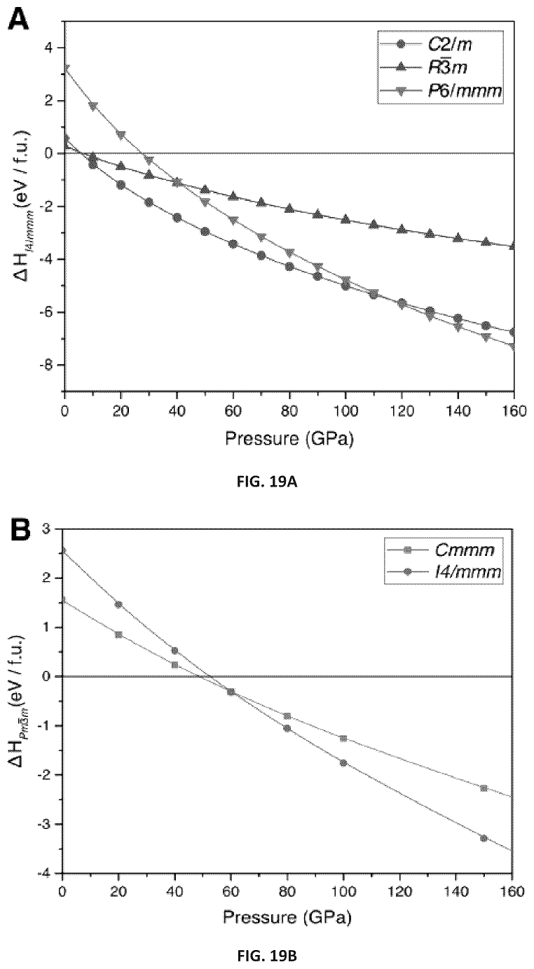

FIG. 19A and FIG. 19B provide energetic stabilities as a function of pressure. FIG. 19A shows calculated enthalpies (H) per SrC₂ unit as a function of pressure for various structures with respect to 14/mmm structure. FIG. 19B shows calculated enthalpies (H) per SrB₆ unit as a function of pressure for various structures with respect to Pm3̅m structure.

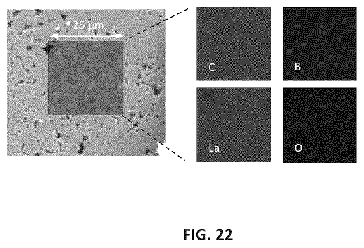

FIG. 22 provides an EDX map of recovered sample showing homogeneous elemental distribution in heated region (25×25 μm2) with average composition La_{1.00±0.07}B_{2.95±0.06}C_{4.20±0.09}O_{0.46±0.07}. The carbon content is biased by adventitious sources, also observed on pure standards. The color composite map is layered over the SEM image and individual elements from the same region are shown below.

Table 1 provides single-crystal diffraction and refinement parameters obtained from LaB₃C₃ crystal synthesized at 57 GPa and >3000 K. The analysis confirms the bipartite sodalite framework and primitive cubic space group.

TABLE 1
Structural Information for LaB₃C₃ from high-
pressure single-crystal X-ray diffraction.

| Empirical formula | LaB₃C₃ |
|---|---|
| Formula weight | 207.37 |
| T/K | 293(2) |
| Crystal system | cubic |
| Space group | Pm3̅n |
| a/Å | 4.6712(16) |
| V/Å³ | 101.93(10) |
| Z | 2 |
| p_{calc}/g · cm⁻³ | 6.757 |
| μ/mm⁻¹ | 20.514 |
| F(000) | 180.0 |
| Crystal size/mm³ | 0.005 × 0.005 × 0.005 |
| Radiation | synchrotron (λ = 0.40663) |
| 2Θ range for data collection/° | 9.988 to 29.844 |
| Index ranges | −4 ≤ h ≤ 5, |
| | −4 ≤ k ≤ 4, |
| | −4 ≤ l ≤ 3 |
| Reflections collected | 81 |
| Independent reflections | 21 [Rᵢₙₜ = 0.0452, |
| | R_{sigma} = 0.0280] |
| Data/restraints/parameters | 21/0/4 |
| Goodness-of-fit on F² | 1.109 |
| Final R indexes [I >= 2_{σ} (I)] | R₁ = 0.0290, wR₂ = 0.0633 |
| Final R indexes [all data] | R₁ = 0.0297, wR₂ = 0.0658 |
| Largest diff. peak/hole/eÅ⁻³ | +0.79/−0.77 |

With respect to a clathrate compound with composition LaB₃C₃, work related to this compound was published in 2021 (Strobel, Angew. Chem. 2021,https://doi.org/10.1002/ange.202012821). LaB₃C₃ is a semiconductor, opposed to metallic/superconducting SrB₃C₃. Given that LaB₃C₃ is isostructural with SrB₃C₃, it is likely that many additional compositions with different guest atoms are possible, as well as different boron/carbon distribution schemes and entirely different clathrate structure types. The present application demonstrates that a large number of compositions are indeed possible, and further demonstrates the formation and properties of new structure types.

In addition to the SrB₃C₃ and LaB₃C₃ clathrates, the inventors also computationally predicted a related clathrate with composition ScB₃C₃. This clathrate has a different structure than Sr/LaB₃C₃ and crystallizes in the noncentrosymmetric space group Ama2. ScB₃C₃ is predicted to be a ferroelectric material with a critical temperature near 370 K. This work was published in 2020 (Zhu, Phys. Rev. Lett., 2020, https://doi.org/10.1103/PhysRevLett.125.127601).

Given the stability of SrB₃C₃ and LaB₃C₃, as demonstrated above and in the Prior Applications, the inventors performed extensive density functional theory (DFT) calculations to examine the energetic and dynamic stabilities of related compounds with various guest atom substitutions. The computational and experimental methods used to investigate these compounds were similar to those described in the Prior Applications, except where otherwise disclosed in this application.

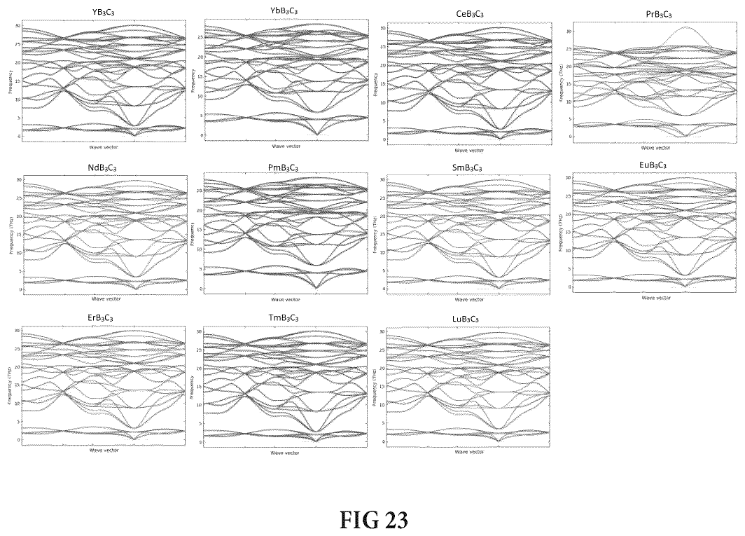

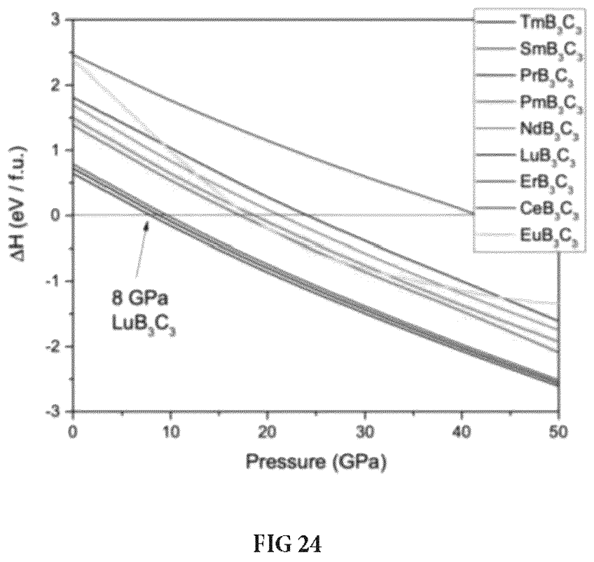

After structural optimization at ambient pressure, it was determined that BaB₃C₃, Y B3C₃, CeB₃C₃, PrB₃C₃, NdB₃C₃, PmB₃C₃, SmB₃C₃3, EuB₃C₃, ErB₃C₃, TmB₃C₃, YbB₃C₃, and LuB₃C₃ are all dynamically stable as shown in FIG. 23. The compounds show negative formation enthalpies at pressures as low as 8 GPa as shown in FIG. 24. The phonon dispersion relations and formation enthalpies were calculated with methods similar to those above (e.g. in FIG. 6A) and were recently published in the supporting material of Geng et al. J. Am. Chem. Soc, 2023, https://doi.org/10.1021/jacs.2c10089. These results strongly support the claim that Type-VII B-C clathrates in the bipartite sodalite structure (cubic MB₃C₃) are possible for many different guest metals, and may provide a variety of useful compounds with varying and tunable properties. The inventors have recently also synthesized a Type-VII CaB₃C₃ clathrate-like compound. Thus, Type-VII clathrates represent a large class of new materials with highly tunable properties depending on the specific guest atoms.

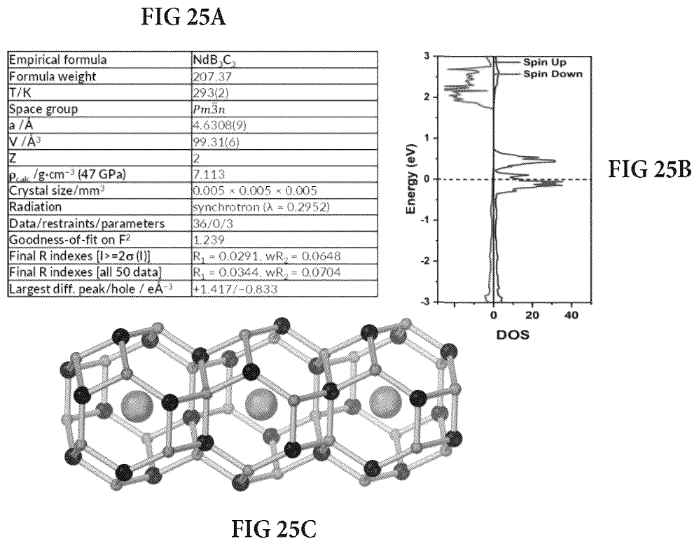

Experimentally, a new MB₃C₃ clathrate was verified for Nd guest atoms, showing that the theorized compounds can be prepared and analyzed in the physical world. Single-crystal refinement parameters for NdB₃C₃ are shown in FIG. 25A, with the spin-polarized density of states shown in FIG. 25B. Single-crystal X-ray diffraction measurements show the cubic bipartite sodalite lattice shown in FIG. 25C. Nd atoms within the structure were calculated to exhibit ferromagnetic ordering, indicating that Type-VII B-C clathrates may also serve as novel magnetic materials.

These findings clearly support the claim that MB₃C₃ clathrates represent a broad class of novel materials with tunable properties. Depending on the metal guest atom these materials may be metals/superconductors, semiconductors and/or ferroelectric/ferromagnetic materials.

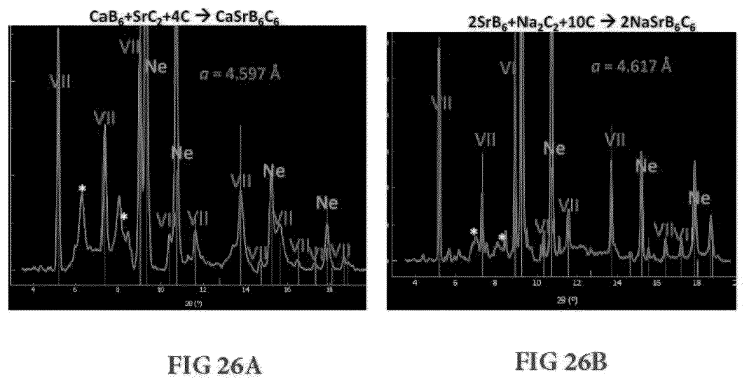

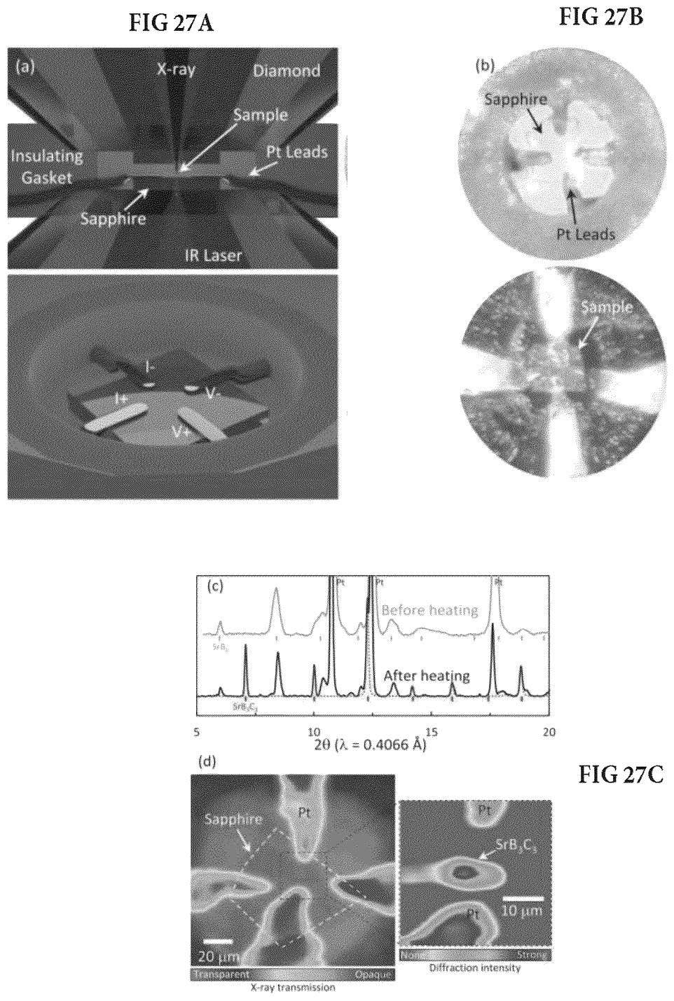

In addition to MB₃C₃ clathrates with one type of guest atom in the cages, the inventors have demonstrated that different metal atoms may occupy the cages in the form of binary guest clathrates, i.e. M1M2B6C₆. Starting from precursor mixtures of metal borides and metal carbides with different metals, i.e., M1B6+M2C₂ the high-pressure synthetic process results in the formation of binary guest clathrates. FIG. 26A shows powder X-ray diffraction patterns for one such compound, namely CaSrB₆C₆ (Ca_{0.5}Sr_{0.5}B₃C₃) obtained after high-pressure laser heating of CaB₆+SrC₂+4 C. FIG. 26B shows powder X-ray diffraction patterns for another such compound, namely NaSrB₆C₆ (NaₓSr₍₁₋ₓ₎B₃C₃) obtained after high-pressure laser heating of 2SrB₆+Na₂C₂+10 C. Based on these results, a large, combinatorial number of M1ₓM2_{y}B₆C₆ (or similar) compounds may be produced following this approach. The below discussion of FIGS. 27A, 27B, and 27C demonstrates a technique for the generation and examination of such compounds.

As mentioned above, MB₃C₃ compounds may serve as moderately high-temperature superconductors depending on the specific guest composition. In 2017, the inventors predicted that SrB₃C₃ exhibits superconductivity at 1 atm with T_{c}≈42 K (u*=0.1). (Li Zhu, Hanyu Liu, R. E. Cohen, Roald Hoffmann, Timothy A. Strobel, Prediction of a thermodynamically stable carbon-based clathrate, arXiv: 1708.03483, https://doi.org/10.48550/arXiv.1708.03483) In June 2017 the inventors also predicted that BaB₃C₃ exhibits superconductivity with T_{c}≈45 K (μ*=0.1). Recently, the inventors have validated the predictions for SrB₃C₃ experimentally and have shown T_{c}≈22 K at 23 GPa. The inventors developed a novel experimental technique that allows for the measurement of in situ electrical transport in high-pressure, high-temperature diamond anvil cells (DAC) with in situ synthesis at ˜50 GPa and temperatures >3000 K. This was achieved by producing an insulating DAC gasket equipped with Pt electrical contacts that rest on top of a sapphire crystal that thermally insulates the diamond anvils during high-temperature laser heating.

FIG. 26A shows a sample geometry for in situ electrical transport with HPHT synthesis of SrB₃C₃. The 1Sr:3B:3C precursor is pressed between diamond anvils, separated by sapphire single crystals that serve as thermal insulation. Four Pt electrical probes sit on the bottom sapphire crystal and are secured within the insulating gasket. FIG. 27B shows photomicrographs of the sample chamber before loading (with view through the top diamond), and after loading sample (view through the bottom diamond). FIG. 27C shows representative XRD patterns before and after heating. The heated region shows ˜60 wt. % SrB₃C₃ with unconverted cubic SrB₆. FIG. 27D shows an X-ray radiograph of the sample chamber with four Pt wires. Outline of the sapphire is indicated by the white dashed line. The dashed black square contains the laser-heated region between the Pt contacts. The zoom window shows an x-ray-diffraction intensity map for SrB₃C₃ and Pt showing the synthesized sample between the contacts.

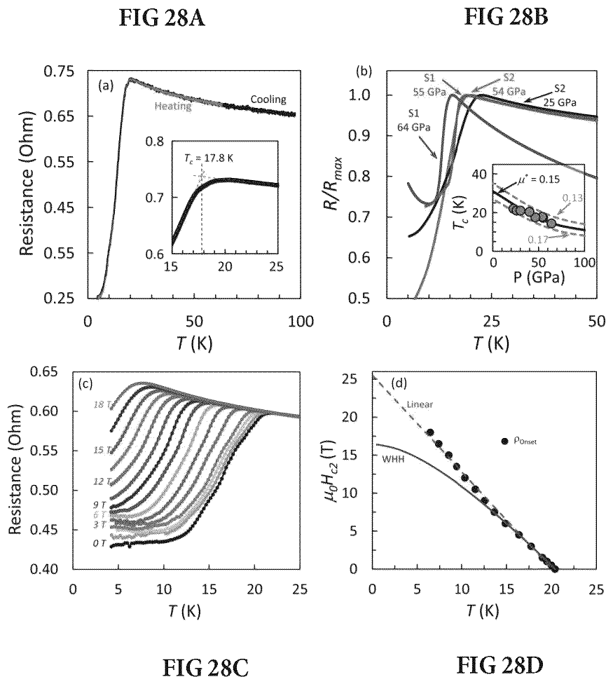

After in situ HPHT synthesis, SrB₃C₃ samples within DACs were placed within open-flow cryostats to measure temperature-dependent electrical transport. Due to resistive precursor present at the sample contacts, samples initially show semiconductor behavior upon cooling. After cooling below ˜20 K, samples show sharp, non-hysteretic, drops in resistance, consistent with a superconducting transition under percolative transport as shown in FIG. 28A. The onset temperature of the resistance drop follows the calculated pressure dependence for T. of SrB₃C₃ with a Coulomb pseudopotential (μ*) value of ˜0.15 as shown in FIG. 28B.

Superconductivity was verified by measuring electrical transport under applied magnetic fields using a non-magnetic DAC. With increasing magnetic field strength, the onset temperature of the resistance drop is suppressed up to a critical field H_{c}2 (T), where superconductivity is destroyed. Resistance at a pressure of 40 GPa as a function of temperature and magnetic field is shown in FIG. 28C. Complementary differential resistance measurements also confirm superconductivity, showing a peak a zero bias when measured below T_{c} and H_{c}2. FIG. 28D shows μ₀H_{c}2 (T) for the transition onset (black points) compared with the WHH model (α=0). A linear fit is shown to guide the eye. The experimental work demonstrating these results was recently published in Phys. Rev. Research 5, 013012 (2023) https://journals.aps.org/prresearch/abstract/10.1103/PhysRevResearch.5.013012 (also posted on arXiv at https://arxiv.org/ftp/arxiv/papers/1708/1708.03483.pdf).

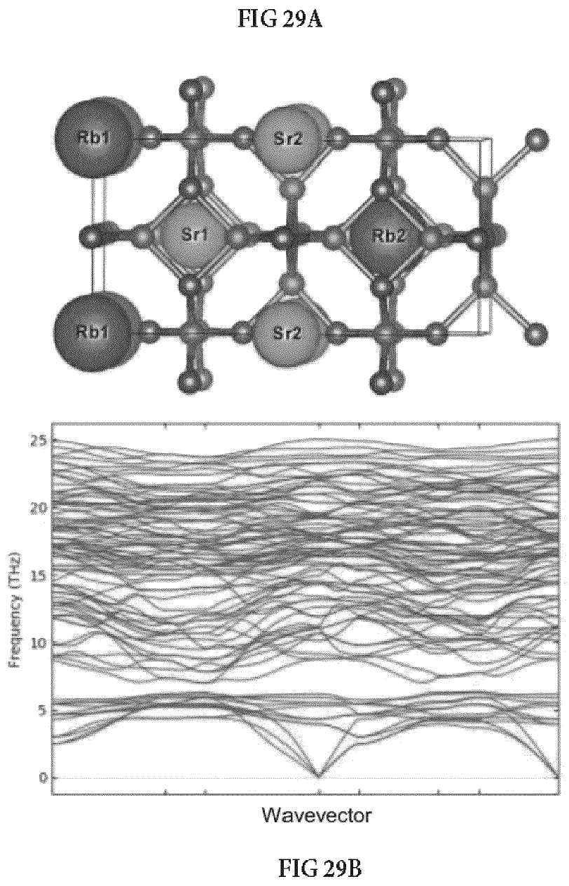

In addition to simple (single metal guest) Type-VII clathrates such as SrB₃C₃ and BaB₃C₃, the inventors predict superconductivity in binary Type-VII clathrates. In this case, different ratios of metal atoms containing different valences can be used to precisely tune the density of states at the Fermi level and significantly enhance T_{c}. For example, in September 2018, the inventors predicted that RbSrB₆C₆ (FIG. 29A, based on a 2×2×1 supercell of SrB₃C₃) is dynamically stable at 1 atm and possessed T_{c} of 50 K, which is enhanced by hole doping, shifting the Fermi level closer to a peak in the electronic density of states. As above, this can also be denoted as Rb_{0.5}Sr_{0.5}B₃C₃. The phonon dispersion of RbSrB₆C₆ at 1 atm showing dynamic stability is shown in FIG. 29B.

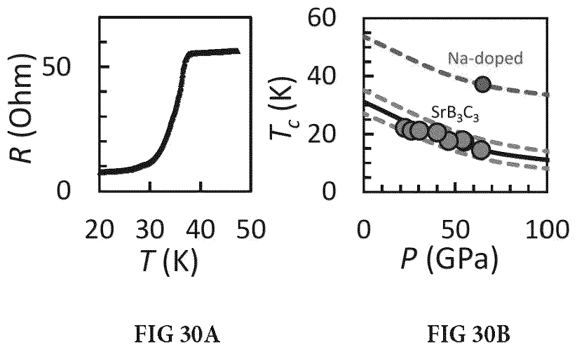

Following the inventors' predictions on hole-doped, binary Type-VII clathrates and positive synthesis experiments (See FIG. 26), the inventors performed electrical transport measurements on NaₓSr₍₁₋ₓ₎B₆C₆ clathrate samples produced at ˜60 GPa and ˜3000 K. Upon cooling, the inventors observed a sharp drop in the electrical resistance similar to SrB₃C₃, but the onset temperature is shifted nearly +20 K as shown in FIG. 30A. This result suggests an enhancement in the superconducting transition temperature and is consistent with theoretical predictions. As shown in FIG. 30B, the T_{c} vs P curve of an Na-doped compound is similar to that of the compound SrB₃C₃, only shifted by nearly +20K.

The inventors recently published predictions of high-T_{c} superconductors for other binary M1M2B₆C₆ clathrates including novel compositions such at KPbB₆C₆ (Geng et al. J. Am. Chem. Soc, 2023, https://doi.org/10.1021/jacs.2c10089). Over the past year other groups have also made predictions of high-T_{c}, binary Type-VII clathrates based on the inventors' initial work on SrB₃C₃ (See: Ting-Ting Gai, Peng-Jie Guo, Huan-Cheng Yang, Yan Gao, Miao Gao, and Zhong-Yi Lu, Van Hove Singularity induced phonon-mediated superconductivity above 77 K in hole-doped SrB₃C₃, Phys. Rev. B 105, 224514, Published 27 Jun. 2022.

https://journals.aps.org/prb/abstract/10.1103/PhysRevB.105.224514. See also: Simone Di Cataldo, Shadi Qulaghasi, Giovanni B. Bachelet, and Lilia Boeri, High-Tc superconductivity in doped boron-carbon clathrates, Phys. Rev. B 105, 064516, Published 25 Feb. 2022, https://journals.aps.org/prb/abstract/10.1103/PhysRevB.105.064516).

According to one aspect of the invention, the inventors have predicted and synthesized the carbon-based clathrate-like structure with Ca as the guest atom. The clathrate-like compound h-CaB₃C₃ is different in many respects from other carbon clathrate compounds discussed above. Note that the inventors have also produced the cubic bipartite sodalite clathrate with the same compositions, but distinct structure.

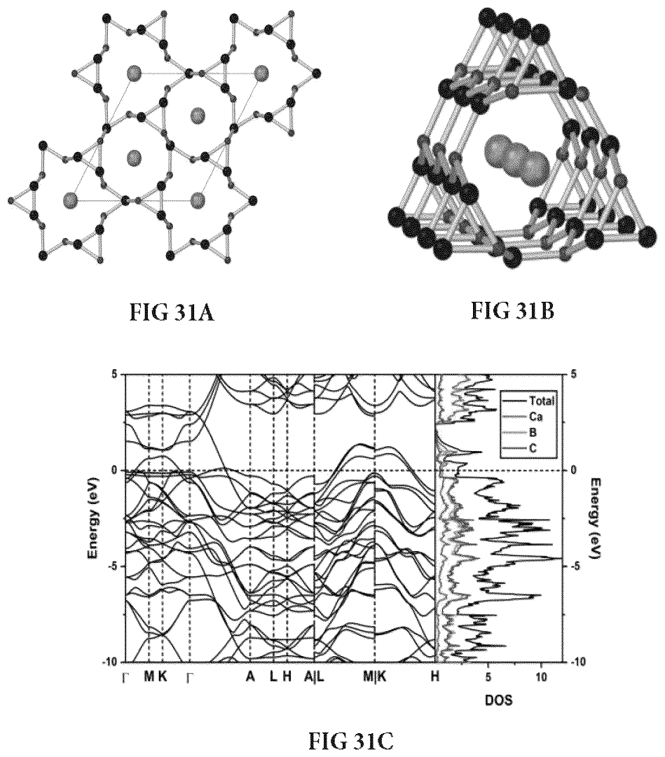

The inventors report having synthesized a new compound with hexagonal symmetry in the space group P-62m and composition CaB₃C₃. While the composition is the same as cubic Type-VII clathrate, the structure type is entirely new as shown in FIG. 31A. Hexagonal CaB₃C₃ is clathrate-like but does not contain closed polyhedral cages. It contains “star-like” channels down the crystallographic c-axis, which potentially indicate mobility of Ca²⁺ ions for possible divalent battery applications as shown in FIG. 31B. It is also metallic with appreciable density of states at the Fermi level, indicating potential for superconductivity. As shown by the experimental data in FIG. 31C, with channels down the c-axis, the electronic band structure and density of states show that the compound is metallic.

As the present invention may be embodied in several forms without departing from the spirit or essential characteristics thereof, it will be understood that the invention is not limited by the details of the foregoing description, unless otherwise specified, but rather should be construed broadly within its spirit and scope as defined in the appended claims, and therefore all changes and modifications that fall within the metes and bounds of the claims. Accordingly, the invention is defined by the appended claims wherein:

What is claimed is:

1. A carbon-based clathrate compound comprising:
(i) a clathrate lattice with atoms of at least one element selected from the group consisting of carbon and boron as a host cage structure; and
(ii) guest atoms encapsulated within the clathrate lattice wherein the guest atoms are selected from a group consisting of neodymium, scandium, yttrium, cerium, praseodymium, promethium, samarium, europium, erbium, thulium, ytterbium, lutetium, and lanthanum.

2. A carbon-based clathrate compound comprising:
(i) a clathrate lattice with atoms of at least one element selected from the group consisting of carbon and boron as a host cage structure; and
(ii) at least two different types of guest atoms encapsulated within the clathrate lattice.

3. The carbon-based clathrate compound of claim 2, wherein the at least two guest atoms are selected from the group consisting of a first guest atom pair sodium and strontium and a second guest atom pair calcium and strontium.

4. A compound of the formula CaB₃C₃.

5. The compound of claim 4, wherein the compound is a carbon-based clathrate-like structure.

6. The compound of claim 5, wherein the structure of the carbon-based clathrate-like structure is hexagonal.

7. The compound of claim 5 comprising a clathrate lattice-like structure with atoms selected from the group consisting of carbon and boron as a host environment structure.

8. The compound of claim 5, wherein the clathrate lattice-like structure is formed of sp³ hybridized carbon and boron.

9. The compound of claim 5, wherein calcium is a guest atom encapsulated within the clathrate lattice-like structure.

10. The compound of claim 8, wherein the clathrate lattice-like structure comprises star-shaped channels down the crystallographic c-axis.

11. A compound of the formula NaₓSr₍₁₋ₓ₎B₃C₃.

12. The compound of claim 11, wherein the compound is a carbon-based clathrate.

13. The compound of claim 12, wherein the structure of the carbon-based clathrate is cubic bipartite socialite.

14. The compound of claim 12 comprising a clathrate lattice with atoms selected from the group consisting of carbon and boron as a host cage structure.

15. The compound of claim 12, wherein the clathrate lattice is formed of sp³ hybridized carbon and boron.

16. The compound of claim 12, wherein sodium is a first guest atom encapsulated within the clathrate lattice and strontium is a second guest atom encapsulated within the clathrate lattice.

17. The compound of claim 15, wherein the clathrate lattice comprises cages, each cage comprising 24 atoms with six four-sided faces and eight six-sided faces.

18. The compound of claim 16, wherein the clathrate lattice comprises cages, each cage comprising 24 atoms with six four-sided faces and eight six-sided faces.

19. The compound of claim 18, wherein the first guest atom is encapsulated within the group of six four-sided faces and the second guest atom is encapsulated within the group of eight six-sided faces.

20. A compound of the formula CaₓSr₍₁₋ₓ₎B₃C₃.

21. The compound of claim 20, wherein the compound is a carbon-based clathrate.

22. The compound of claim 21, wherein the structure of the carbon-based clathrate is cubic bipartite socialite.

23. The compound of claim 21 comprising a clathrate lattice with atoms selected from the group consisting of carbon and boron as a host cage structure.

24. The compound of claim 21, wherein the clathrate lattice is formed of sp³ hybridized carbon and boron.

25. The compound of claim 21, wherein calcium is a first guest atom encapsulated within the clathrate lattice and strontium is a second guest atom encapsulated within the clathrate lattice.

26. The compound of claim 24, wherein the clathrate lattice comprises cages, each cage comprising 24 atoms with six four-sided faces and eight six-sided faces.

27. The compound of claim 5, wherein the clathrate lattice comprises cages, each cage comprising 24 atoms with six four-sided faces and eight six-sided faces.

28. The compound of claim 27, wherein the first guest atom is encapsulated within the group of six four-sided faces and the second guest atom is encapsulated within the group of eight six-sided faces.
